(19) United States
(12) Patent Application Publication
(10) Pub. No.: US 2011/0169197 A1
(43) Pub. Date: Jul. 14, 2011

(54) Fabricating Polymer Stents with Injection Molding

(76) Inventors: Bin Huang, Pleasanton, CA (US); David C. Gale, San Jose, CA (US); Syed Faiyaz Ahmed Hossainy, Fremont, CA (US)

(21) Appl. No.: 13/072,658

(22) Filed: Mar. 25, 2011

Related U.S. Application Data
(62) Division of application No. 11/477,333, filed on Jun. 28, 2006.

(51) Int. Cl. B29C 35/08

(52) U.S. Cl. 264/478

(57) ABSTRACT

A stent can be made by injecting a molten reaction mixture into a mold. The mold being in the shape of a radially expandable stent. The reaction mixture can have a reactive species capable of causing polymerization or crosslinking in the reaction mixture upon exposure to radiation. The method can include exposing the reaction mixture to radiation to cause polymerization or crosslinking in the reaction mixture.

### CROSS-REFERENCE TO RELATED APPLICATION

This application is a divisional of co-pending application Ser. No. 11/477,333, filed Jun. 28, 2006, which is incorporated herein by reference.

### BACKGROUND OF THE INVENTION

1. Field of the Invention

This invention relates to fabricating polymer stents with injection molding.

2. Description of the State of the Art

This invention relates to radially expandable endoprostheses, which are adapted to be implanted in a bodily lumen. An “endoprosthesis” corresponds to an artificial device that is placed inside the body. A “lumen” refers to a cavity of a tubular organ such as a blood vessel.

A stent is an example of such an endoprosthesis. Stents are generally cylindrically shaped devices, which function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of the diameter of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

The treatment of a diseased site or lesion with a stent involves both delivery and deployment of the stent. “Delivery” refers to introducing and transporting the stent through a bodily lumen to a region, such as a lesion, in a vessel that requires treatment. “Deployment” corresponds to the expanding of the stent within the lumen at the treatment region. Delivery and deployment of a stent are accomplished by positioning the stent about one end of a catheter, inserting the end of the catheter through the skin into a bodily lumen, advancing the catheter in the bodily lumen to a desired treatment location, expanding the stent at the treatment location, and removing the catheter from the lumen.

In the case of a balloon expandable stent, the stent is mounted about a balloon disposed on the catheter. Mounting the stent typically involves compressing or crimping the stent onto the balloon. The stent is then expanded by inflating the balloon. The balloon may then be deflated and the catheter withdrawn. In the case of a self-expanding stent, the stent may be secured to the catheter via a retractable sheath or a sock. When the stent is in a desired bodily location, the sheath may be withdrawn which allows the stent to self-expand.

The stent must be able to satisfy a number of mechanical requirements. First, the stent must be capable of withstanding the structural loads, namely radial compressive forces, imposed on the stent as it supports the walls of a vessel. Therefore, a stent must possess adequate radial strength. Radial strength, which is the ability of a stent to resist radial compressive forces, is due to strength and rigidity around a circumferential direction of the stent. Once expanded, the stent must adequately maintain its size and shape throughout its service life despite the various forces that may come to bear on it, including the cyclic loading induced by the beating heart. For example, a radially directed force may tend to cause a stent to recoil inward. Due to loads applied during crimping, deployment, and after deployment a stent can experience substantial stress of localized portions of the stent's structure.

In addition, the stent must possess sufficient flexibility to allow for crimping, expansion, and cyclic loading. Longitudinal flexibility is important to allow the stent to be maneuvered through a tortuous vascular path and to enable it to conform to a deployment site that may not be linear or may be subject to flexure.

The structure of a stent is typically composed of scaffolding that includes a pattern or network of interconnecting structural elements often referred to in the art as struts or bar arms. The scaffolding can be formed from wires, tubes, or sheets of material rolled into a cylindrical shape. The scaffolding is designed so that the stent can be radially compressed (to allow crimping) and radially expanded (to allow deployment). A conventional stent is allowed to expand and contract through movement of individual structural elements of a pattern with respect to each other.

Additionally, a medicated stent may be fabricated by coating the surface of either a metallic or polymeric scaffolding with a polymeric carrier that includes an active or bioactive agent or drug. Polymeric scaffolding may also serve as a carrier of an active agent or drug.

Furthermore, it may be desirable for a stent to be biodegradable. In many treatment applications, the presence of a stent in a body may be necessary for a limited period of time until its intended function of, for example, maintaining vascular patency and/or drug delivery is accomplished. Therefore, stents fabricated from biodegradable, bioabsorbable, and/or bioerodable materials such as bioabsorbable polymers should be configured to completely erode only after the clinical need for them has ended.

However, there are potential shortcomings in the use of polymers as a material for stents. Stents made from polymers can have insufficient radial strength and be subject to recoil upon implantation. Manufacturing methods are needed that can fabricate stents with sufficient radial strength, low recoil, and sufficient shape stability.

### SUMMARY OF THE INVENTION

Certain embodiments of the present invention include a method of fabricating a stent comprising: injecting a molten polymer into a mold, the mold being in the shape of a cylindrical radially expandable stent including at least one structural element, the mold having at least one conduit to form the at least one structural element; cooling the molten polymer below the Tm of the polymer, wherein the cooled molten polymer forms the stent, wherein the stent is capable of being disposed within a bodily lumen; and removing the stent from the mold.

Further embodiments of the present invention include a method of fabricating a stent comprising: disposing a molten reaction mixture into a mold, the mold being in the shape of a radially expandable stent including at least one structural element, the reaction mixture comprising reactive species capable of causing polymerization or crosslinking in the reaction mixture upon exposure to radiation; and exposing the mold to radiation, the radiation causing polymerization or crosslinking in the reaction mixture within the mold, the stent being formed from a polymer formed from the polymerization or crosslinking.

### BRIEF DESCRIPTION OF THE DRAWINGS

FIG. 1 depicts a stent.

FIG. 2 depicts a cross-sectional view of a stent substrate with a coating.

FIGS. 3A-C depict structural elements from the stents depicted in FIGS. 2A-C.

FIGS. 4A-B depicts a schematic axial cross-section of a mold for fabricating a coil stent.

FIG. 5 depicts a time-line of the injection molding process.

FIG. 6A-B depict a stent disposed over a balloon.

FIG. 7 depicts a schematic plot of the crystal nucleation rate, the crystal growth rate, and the overall rate of crystallization vs. temperature.

FIG. 8 depicts a synthetic route to forming a reactive copolymer.

### DETAILED DESCRIPTION OF THE INVENTION

The various embodiments of the present invention relate to fabricating polymer stents using injection molding. Some embodiments include fabricating stents using high speed injection molding. Other embodiments involve using reaction injection molding to fabricate a stent. The present invention can be applied to devices including, but is not limited to, self-expandable stents, balloon-expandable stents, stent-grafts, and grafts (e.g., aortic grafts).

A person of ordinary skill in the art is familiar with injection molding. In general, “injection molding” refers to a manufacturing technique for making parts from polymers or plastic material. Molten plastic is injected at high pressure into a mold, which is the inverse of the desired shape. The mold can be made from metal, usually either steel or aluminium, and precision-machined to form the features of the desired part.

There are several advantages of injection molding over other fabrication techniques for making stents. For example, a polymer stent can be fabricated from a polymer tube by laser cutting a pattern into the tube that includes desired structural elements. The laser process can result in a high temperature heating zone that can potentially damage polymer adjacent to the edge of struts. Additionally, struts cut by a laser tend to have sharp corners that can cause injury to a vessel or cause unstable blood flow after implantation. However, with injection molding, a stent with its structural elements can be formed in a mold in a finished state. Therefore, there may be no need for laser cutting.

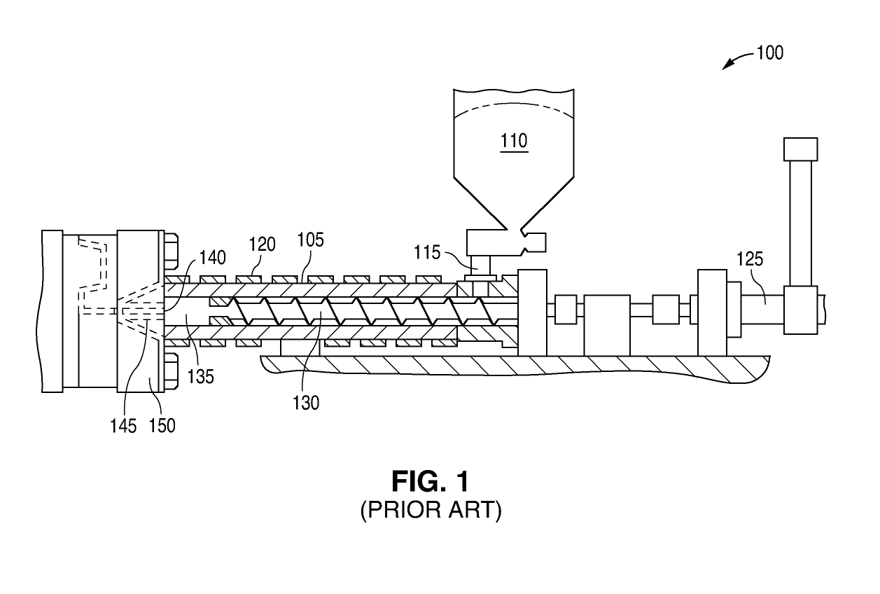

FIG. 1 depicts a prior art injection molding apparatus 100. Apparatus 100 includes a barrel 105 and a feeder 110 in which the barrel is adapted to receive the polymer material from the feeder through an inlet 115 positioned proximate a first (inlet) end of the barrel. The material is generally received in a solid form, such as pellet, chip, flake, powder or the like, or as a polymer melt. Depending on the form of material that is received into the barrel, heating elements 120 either heat the polymer material or maintain it at a predetermined temperature.

Positioned in barrel 105 and rotated by an actuator 125 is a reciprocating screw 130, that moves the polymer material through barrel 105 while applying a shearing action to the material. Screw 130 can also retract and push forward without rotation to act as a plunger. Screw 130 increases heat transfer to the walls of barrel 105 and converts mechanical energy to heat energy.

Following the collection of an appropriate amount of polymer material at a second (exit) end 135 of barrel 105, screw 22 is rapidly rotated, thereby moving the polymer material through an outlet 140 of barrel 105, then through a nozzle 145 and finally into a mold or die 150. In the die, the material solidifies as it cools and the newly formed injection molded part may be removed from the die.

In high speed injection molding, the polymer is injected into the mold at substantially higher speed and pressure than is done in conventional injection molding. Higher speed and pressures allow injection molding to be performed at lower temperatures which reduces degradation of the polymer. In conventional injection molding, injection pressures tend between about 35-160 MPa and injection speeds tend to be less than 400 mm/sec. In high speed injection molding injection speeds can be greater than 500 mm/sec, 1000 mm/sec, or greater than 2000 mm/sec, and injection pressures can be greater than 160 MPa, 200 MPa, or greater than 220 MPa.

Embodiments of the present invention involve adapting injection molding and high speed injection molding to fabricate stents of arbitrary geometries having high radial strength, low recoil, and shape stability. Additionally, the adverse effects of laser cutting are avoided including sharp edges and surface defects or damage.

Shape stability is associated with phenomena such as creep and stress relaxation. For example, creep refers to the gradual deformation that occurs in a polymeric construct subjected to an applied load. It is believed that the delayed response of polymer chains to stress during deformation causes creep behavior. Creep can lead to recoil of a stent deployed in a vessel.

In general, a stent is a cylindrically shaped structure having at least one structural element. The structural element or structural elements are arranged or designed so that the stent can undergo radial expansion and compression. A structural element can include, for example, a strut, a rod, fiber, wire, or filament. The variation in stent patterns is virtually unlimited.

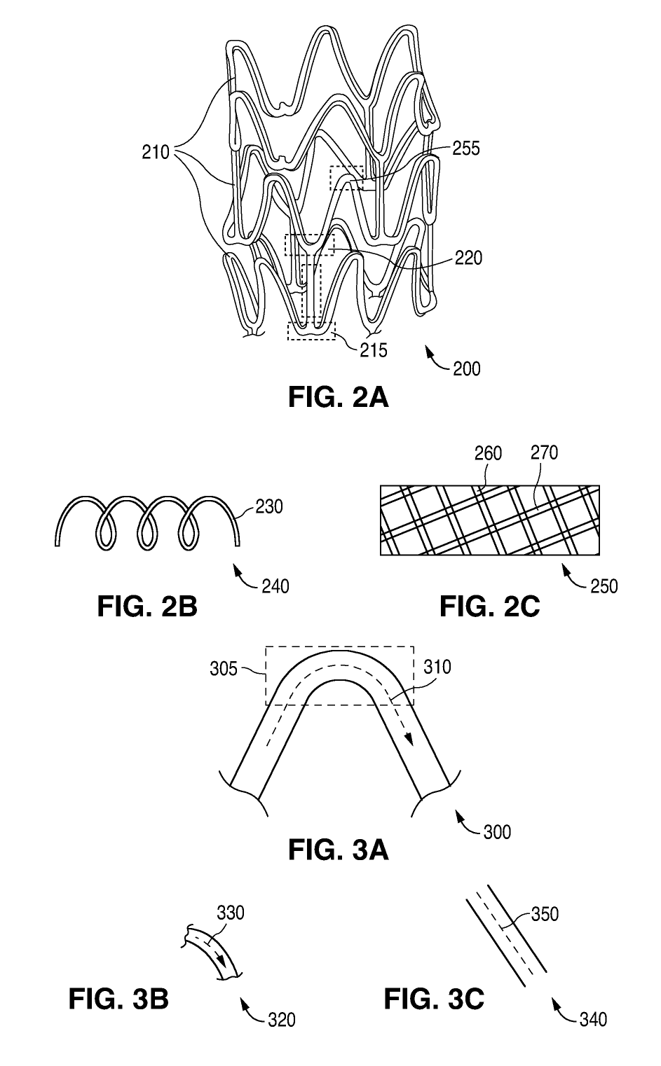

FIGS. 2A-C depict exemplary embodiments of radially expanded stents. FIG. 2A depicts an example of a view of a stent 200. Stent 200 has a cylindrical shape and includes a pattern with a number of interconnecting structural elements or struts 210. Stent 200 has curved portions or regions 215, 220, and 225 that bend inward when the stent 200 is crimped bend outward when the stent is radially expanded and deployed. Stent 200 is a balloon expandable stent since the curved portions tend to undergo plastic deformation when stent 200 is crimped.

FIG. 2B depicts coil stent 230 that includes a structural element 240 in the form of a coil or helix. FIG. 2C depicts a stent 250 having a near-net shaped geometry made up of a plurality of intersecting structural elements, e.g., elements 260 and 270. Stent 240 and 250 are self-expandable stent since the structural element(s) undergo plastic deformation when stents 240 and 250 are crimped.

As indicated above, a stent must have sufficient radial strength to withstand structural loads, namely radial compressive forces, imposed on the stent as it supports the walls of a vessel. A polymeric stent with inadequate radial strength can result in mechanical failure or recoil inward after implantation into a vessel.

It is known by one of ordinary skill in the art that mechanical properties of polymers are related to the degree of orientation of polymer chains in a polymer. Strength and modulus are some of the important properties that depend upon orientation of polymer chains in a polymer. Molecular orientation refers to the relative orientation of polymer chains along a longitudinal or covalent axis of the polymer chains. Regions of a polymer having a high degree of orientation along a preferred direction tend to have high strength and modulus. For example, a drawn fiber has a high degree or orientation along its axis and a correspondingly high strength and modulus along the axis.

In a stent, radial strength can be enhanced by increasing the molecular orientation along the axis of structural elements that undergo significant stress and strain when the stent in under an applied load. For example, FIGS. 3A-C depict structural elements from the stents depicted in FIGS. 2A-C. FIG. 3A depicts a bending element 300 of stent 200 in FIG. 2A. A curved portion 305 of bending region 300 undergoes high stress and strain during crimping, deployment, and after deployment. The stress and strain tend to follow an axis 310 or curvature of the curved region. Similarly, FIGS. 3B and 3C depict portions 320 and 340 of structural elements from stents 240 and 250, respectively. The stress and strain trend to follow axis 330 and 350 of stents 240 and 250, respectively.

Certain embodiments of a method of fabricating a stent by injection molding can include injecting a molten polymer into a mold. The mold can be in the shape of a radially expandable stent. In particular, the mold can include one or a plurality of elongated cavities, channels, or conduits that correspond to the structure of a stent, such as those depicted in FIG. 2A-C.

The injected polymer melt flows through the conduits or channels of the mold to form the structural elements of the stent. In general, the flow of a polymer melt can induce a linear molecular orientation in the direction of or along an axis of the flow. Thus, in one embodiment, the flow of the injected polymer melt through mold conduits induces orientation in polymer chains along the axis of the conduits of the mold. In some embodiments, a high speed injection molding process can be used. The high speed and pressure of injection of a polymer melt into the mold in high speed injection molding results in a higher flow speed in the mold conduits, resulting in further enhancement of molecular orientation. The injection speed can be greater than 500 mm/sec, 1000 mm/sec, or greater than 2000 mm/sec, and injection pressures can be greater than 160 MPa, 200 MPa, or greater than 220 MPa.

There is a tendency for polymers to rearrange from the linear state to a coiled state in a melt phase in the absence of an external force, such as the shear force of a flow. Thus, once the flow slows or stops, the linearly oriented polymer chains tend to relax and molecular orientation dissipates. The stopping of the flow will correspond to the filling of the mold. The induced molecular orientation, however, can be retained by solidifying the polymer, i.e., by decreasing the polymer to a temperature below its Tm. Therefore, the polymer melt in the mold should be cooled below Tm before substantial relaxation of polymer chains can occur. The degree of relaxation that a polymer experiences is a complex function that is dependant on the temperature of the polymer, the molecular weight of the polymer, the rate of cooling of the polymer, and the type of polymer used. The appropriate parameters for a specific process can be readily determined experimentally by one of skill in the art. For example, strength and orientation of a structural element can be determined as a function of cooling temperature. Molecular orientation in polymers can be determined for both amorphous and crystalline polymers. Polymer and Engineering and Science, September 1981, Vol. 21, No. 13.

In one embodiment, the temperature of the polymer in the mold can be controlled by the mold temperature. The temperature of the mold can be controlled to a relatively narrow tolerance, for example, by a recirculating water bath. In one embodiment, the mold can be immersed or surrounded by a chamber containing water at a temperature that cools the mold to a desired temperature. In an embodiment, the channels for cooling water can be circulated through channels within the mold. The temperature of the mold can be controlled to within less than 5° C., 2° C., 1° C., or less than 0.5° C.

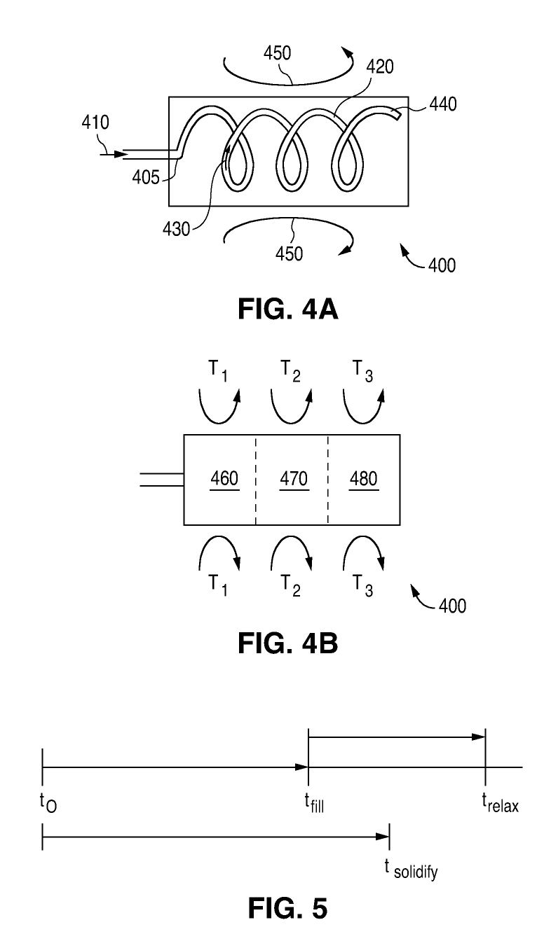

FIG. 4A depicts a schematic axial cross-section of a mold 400 for fabricating a coil stent. Polymer melt is injected into mold 400 at a proximal end 405 of the mold as shown by an arrow 410. The polymer melt flows through a channel or conduit 420 in the shape of a coil stent. Polymer melt flows through conduit 420 as shown by an arrow 430, the flow inducing orientation in polymer chains along the direction of flow. Polymer melt is injected until the mold is filled, i.e., the polymer melt fills conduit 420 up to a distal end 440. Cooling fluid is recirculated adjacent to mold 400 as shown by arrows 450.

It is advantageous for the cooling of the polymer melt to have at least two constraints. The constraints allow the formation of a complete structure of the stent and retention of all or substantially all of the induced linear molecular orientation in the structural elements. First, the polymer melt should not solidify until all or substantially all of the mold is filled with polymer melt. This is important because it is desirable to mold a complete part. Second, upon filling of the mold, the time to solidify (measured from filling of the mold) should be less than the time for polymer chains to substantially relax from a linear oriented state to coiled state within the mold conduits.

FIG. 5 depicts a time-line of the injection molding process illustrating the above-mentioned constraints. t₀ corresponds to the time at which injection of polymer melt into the mold begins. t_{fill} corresponds to the time at which the mold is filled. The time for the polymer melt to solidify, t_{solidify}, is shown to be greater than t_{fill}. tᵣₑₗₐₓ is the time for relaxation of the polymer chains from the induced linear orientation to a coiled configuration in a polymer melt and is measured from when the mold is filled. The polymer is shown to solidify at t_{solidify} before the polymer chains are relaxed at tᵣₑₗₐₓ.

In general, the temperature profile along the mold is not constant along the mold. Referring to FIG. 4A, as the polymer melt flows from proximal end 405 to distal end 440, the temperature decreases. In one embodiment, the temperature of the cooling fluid can compensate for the variation in temperature. For example, the sections of the mold from the proximal end to the distal end can be exposed to recirculating cooling fluid at different temperatures. FIG. 4B depicts mold 400 (conduit 420 not shown). Section 460 is exposed to a temperature T₁, section 470 is exposed to a temperature T₂, and section 480 is exposed to a temperature T₃. In one embodiment, T₁>T₂>T₃, to take into account the decrease in temperature of the polymer melt in conduit 420 between proximal end 405 and distal end 440.

In some embodiments, the above constraints can be achieved by adjusting the injection speed, the mold temperature, or both. At a selected injection speed, the cooling temperature can be adjusted until solidification of the polymer melt occurs at or approximately when the mold is filled or at a time before substantial relaxation of polymer chains occurs. Alternatively, the injection speed can be adjusted at a selected mold or cooling temperature to fill the mold before the polymer melt solidifies. Additionally, the injection speed and mold temperature can be adjusted together to achieve the constraints.

In another embodiment, the injection speed can be tuned or adjusted

In some embodiments, it may be desirable cool or quench the molten polymer from above Tm to below the Tg during cooling. As a result, the cooled polymer is amorphous or substantially amorphous. Although a degree of crystallinity may be desirable in the formed stent, such crystallinity can be introduced in later processing steps, as described blow.

Further embodiments can include additional processing of a stent formed from injection molding. In some embodiments, the formed stent can be radially expanded to enhance the radial strength and modulus of the stent. It is well known by those skilled in the art that the mechanical properties of a polymer can be modified by applying stress to a polymer. James L. White and Joseph E. Spruiell, Polymer and Engineering Science, 1981, Vol. 21, No. 13. The application of stress can induce molecular orientation along the direction of stress which can increase the strength and modulus of the polymer. The radial expansion may induce orientation, and thus, enhance the strength and modulus along the axis of the deformed structural members.

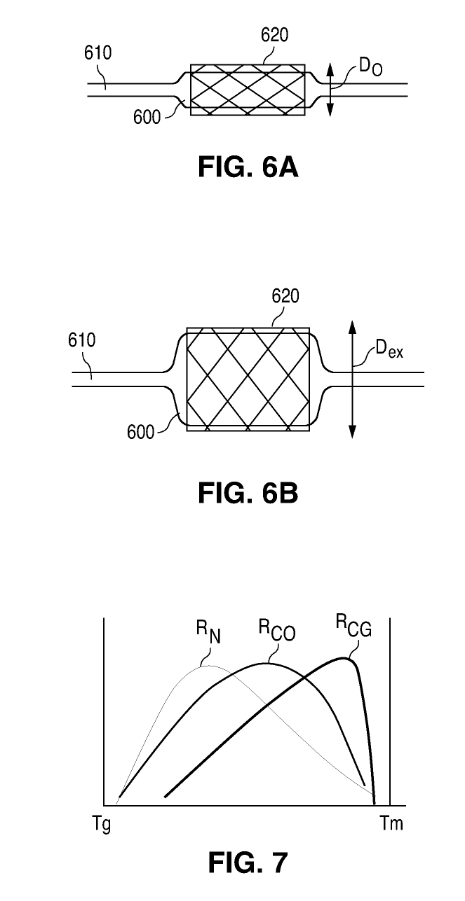

In one embodiment, the formed stent can be expanded by disposing the stent over an inflatable member, such as a balloon. The balloon can then be expanded to expand the stent. FIG. 6A depicts a balloon 600 in deflated condition disposed over a support or catheter 610. A near-net shaped stent 620 with an original or fabricated diameter Dₒ is disposed over balloon 600. Stents such as stent 210 and stent 240 can be expanded in a similar manner. A fluid can be pumped into balloon 600 to inflate balloon 600 which expands stent 620 to a diameter Dex. FIG. 6B depicts balloon 600 in an expanded state along with expanded stent 520.

In one embodiment, the stent can be heated to a temperatures above the Tg of the polymer to facilitate deformation. The stent can be heated prior to, during, and subsequent to the deformation. In one embodiment, the stent can be heated gradually up to a deformation temperature prior to deformation. Alternatively, the stent can be heated rapidly to a deformation temperature and maintained at the temperature during deformation. In one embodiment, the stent may be heated by conveying a gas (e.g., air, nitrogen, argon, etc.) above the Tg or ambient temperature (e.g., between 15° C. and 25° C.) on and/or into the stent. The stent can also be heated by translating a heating element or nozzle adjacent to the tube. In other embodiments, the stent can be heated by a mold disposed over the stent. The mold may be heated, for example, by heating elements on, in, and/or adjacent to the mold.

Additionally, a further processing step can include heat setting the expanded stent. Heat setting refers to maintaining a temperature of the expanded stent at an elevated level, for example, above Tg, for a period of time. Heat setting allows polymer chains to rearrange in order to adopt configurations closer to or at an equilibrium state. The selected period of time may be between about one minute and about two hours, or more narrowly, between about two minutes and about ten minutes.

For a self-expandable stent, the heat setting diameter can be used to control the deployment diameter. Thus, radial expansion followed by heat setting at an expanded diameter can increase the deployment diameter. For example, a stent can be fabricated at a diameter A, heat set at diameter B, crimped to diameter C, and deployed to diameter D. The diameters are related as follows: B≧A and B>D>C.

The temperature of the stent during heat setting can be varied in several ways. In one embodiment, the stent can be heated gradually up to a maximum temperature and maintained for a period of time and then gradually decreased. Alternatively, the stent can be heated rapidly to a maximum temperature and maintained at the temperature for a period of time.

In one embodiment, the stent can be heat set at the expanded diameter. An outward radial force or pressure on an inside or luminal surface of the stent can reduce or prevent recoil inward during heat setting. For example, referring to FIG. 6B, the stent can be maintained at the expanded diameter for a period of time by maintaining the balloon at a pressure that maintains the stent at the expanded diameter.

In another embodiment, the stent can be allowed to recoil radially inward during heat setting. Again referring to FIG. 6B, the balloon can be completely deflated during heat setting so that the stent is allowed to recoil radially inward with no radially restraining force during heat setting.

In a further embodiment, the stent can be heat seat at a diameter less than the expanded diameter. In FIG. 6B, the pressure in balloon 600 can be adjusted so that stent 620 is maintained at the selected diameter.

In certain embodiments, the temperature of the deformation process and/or heat setting can be used to control the degree of crystallinity and the crystal structure. In general, crystallization tends to occur in a polymer at temperatures between Tg and Tm of the polymer. The rate of crystallization in this range varies with temperature. FIG. 7 depicts a schematic plot of the crystal nucleation rate (R_{N}), the crystal growth rate (R_{CG}), and the overall rate of crystallization (R_{CO}) versus temperature. The crystal nucleation rate is the growth rate of new crystals and the crystal growth rate is the rate of growth of formed crystals. The overall rate of crystallization is the sum of curves R_{N} and R_{CG}.

In one embodiment, the temperature can be controlled so that the degree of crystallinity is less than 40%, 30%, 15%, 5%, or more narrowly less than 1%. In one embodiment, the temperature can be in a range in which the crystal nucleation rate is larger than the crystal growth rate. For example, the temperature can be where the ratio of the crystal nucleation rate to crystal growth rate is 2, 5, 10, 50, 100, or greater than 100. In another embodiment, the temperature range may be in range between about Tg to about 0.2(Tm−Tg)+Tg. Under these conditions, the resulting polymer can have a relatively large number of crystalline domains that are relatively small. As the size of the crystalline domains decreases along with an increase in the number of domains, the fracture toughness of the polymer can be increased without the onset of brittle behavior.

Further embodiments of the present invention involve the use reactive injection molding to fabricate a stent. As indicated above, due to the high viscosity of polymer melts, conventional injection molding equipment can have difficulty in forming small, intricately shaped parts, such as cardiovascular stents. Increasing the temperature to decrease the viscosity can result in degradation of the polymer. “Reactive injection molding” (RIM) is a process in which a polymer is formed directly in a mold. RIM involves filling a mold with a low or medium molecular weight material followed by polymerization and/crosslinking within the mold. RIM can allow the fabrication of a stent composed of a crosslinked polymer that has a high degree of shape stability and creep resistance.

In certain embodiments, a method of fabricating a stent can include disposing a molten reaction mixture into a mold in the shape of a cylindrical radially expandable stent including at least one structural element. The reaction mixture can include reactive species capable of causing polymerizing or crosslinking upon exposure to radiation.

Various kinds of radiation can be used to cause crosslinking including, but not limited to, ultraviolet (UV), gamma, ion beam, x-ray, and e-beam. A person of ordinary skill in the art is aware that when the radiation from a UV, ion beam, gamma ray, e-beam, or x-ray source interacts with a polymer material, its energy is absorbed by the polymer material which can cause active species such as radicals to be produced, thereby initiating various chemical reactions.

There are three fundamental processes that are the result of these reactions: (1) crosslinking, where polymer chains are joined and a network is formed; (2) degradation, where the molecular weight of the polymer is reduced through chain scissioning; and (3) grafting, where a new monomer is polymerized and grafted onto the base polymer chain. When monomers are irradiated, polymerization can also be initiated. Different polymers have different responses to radiation.

A parameter called a “G value” is usually used to quantify the chemical yield resulting from the radiation. G value is defined as the chemical yield of radiation in number of molecules reacted per 100 eV of absorbed energy. G-values for crosslinking G(X) and for chain scission G(S) for some of the common polymeric materials can be found in many references. Woods, R. and Pikaev, A., Applied Radiation Chemistry: Radiation Processing, John Wiley & Sons, Inc., New York, 19942. Bradley, R., Radiation Technology Handbook, Marcel Dekker, Inc. New York, 1984. Therefore, a person of ordinary skill in the art can identify chemical species that are capable of being, polymerized or crosslinked upon irradiation.

The reaction mixture can include polymers, prepolymers, monomers, or any combination thereof. The polymers, prepolymers, or monomers can contain reactive end or pendant groups that allow crosslinking or polymerization of the polymers, prepolymer, or monomers upon exposure to radiation. A reaction mixture can include at least one catalyst for a polymerization or crosslinking reaction.

A “prepolymer” is a polymer of relatively low molecular weight, usually intermediate between that of the monomer and the final polymer or resin, which may be mixed with compounding additives, and which is capable of being hardened by further polymerization during or after a forming process. A prepolymer is capable of entering, through reactive groups, into further polymerization or crosslinking and thereby contributing more than one structural unit to at least one type of chain of the final polymer. Representative examples of monomers from which prepolymers can be prepared include, but are not limited to, L-lactide; D-lactide; DL-lactide; glycolide; a lactone; epsilon-caprolactone; dioxanone; trimethylene carbonate; a cyclic carbonate; a cyclic ether; a lactam and mixtures thereof. A prepolymer can have a weight average molecular weight in the range of 500 to 100,000 Daltons, 500 to 50,000 Daltons, or more narrowly, between 500 to 10,000 Daltons.

During or after disposing a molten reaction mixture into a mold, the method may further include exposing the mold containing the reaction mixture to radiation. The radiation can cause crosslinking or polymerization reactions in the reaction mixture resulting in the formation of a crosslinked or higher molecular weight polymer within the mold. It is desirable for the mold to be fabricated from material that can allow transmission of sufficient radiation to polymerize or crosslink the reaction mixture. Mold materials suitable for transmission of UV radiation include, but is not limited to quartz.

Although the radiation dose necessary for adequate crosslinking will depend on a number of factors, a typical dose would lie within the range of 5 kGy to 100 kGy, or more narrowly, 10 kGy to 50 kGy.

The dose of radiation required for completion of a crosslinking reaction depends on the specific type of reaction and molecular weight. The specific energy requirement (energy per unit mass) for radiation-induced chemical reactions is proportional to the absorbed dose (D). According to the definition of the common dose unit, one kilogray (kGy) equals the absorption of 1 kilojoule (kJ) or 1 kilowatt second (kW s) per kilogram (kg) of material. Therefore, the specific energy (SE) requirement in kilojoules per kilogram (kJ/kg) is just equal to the dose in kilograys. The specific energy requirement can also be expressed in terms of the molecular weight (MW) and the G-value (G) of the reaction. The G-value is defined as the number of reactions or events per 100 electron volts (eV) of absorbed energy. In one embodiment, D=9.65×106/G (MW)(kGy).

In one embodiment, the reaction mixture can be in the molten state during exposure to radiation and crosslinking or polymerization. In another embodiment, the reaction mixture can be cooled to a solid state prior to exposing the mold to radiation. Thus, crosslinking or polymerization can be performed in either the solid or molten state. In some embodiments, the reaction mixture can be exposed to radiation in the molten state to crosslink or polymerize the reaction mixture. The reaction mixture can then be allowed to form a solid state, through cooling or hardening due to reactions or both, followed by further exposure to radiation to induce polymerization or crosslinking.

In a further embodiment, the reaction mixture can be cooled to a solid state upon filling the mold without exposing the reaction mixture to radiation. A stent formed from the solidified reaction mixture can then be removed from the mold with no exposure to radiation. The removed stent can then be exposed to radiation to initiate crosslinking or polymerization. In another embodiment, the reaction mixture can be exposed to radiation while in the mold to polymerize and crosslink, removed from the mold, and then exposed to radiation outside of the mold to further crosslink and polymerize a formed stent.

Representative reactive groups that may be used to polymerize or crosslink a reaction mixture include carbon-carbon double bonds. Typical cross linking agents tend to have multiple carbon-carbon double bonds, so that they can link multiple polymer chains together. Examples of cross linking agents include, but are not limited to, triallyl isocyanurate (TAIC) and trimethylallyl isocyanurate (TMAIC). In an exemplary embodiment, pendant or end-groups having carbon-carbon double bonds can be used to crosslink a polymer. UV light can be used to activate the carbon-carbon double bonds to undergo crosslinking.

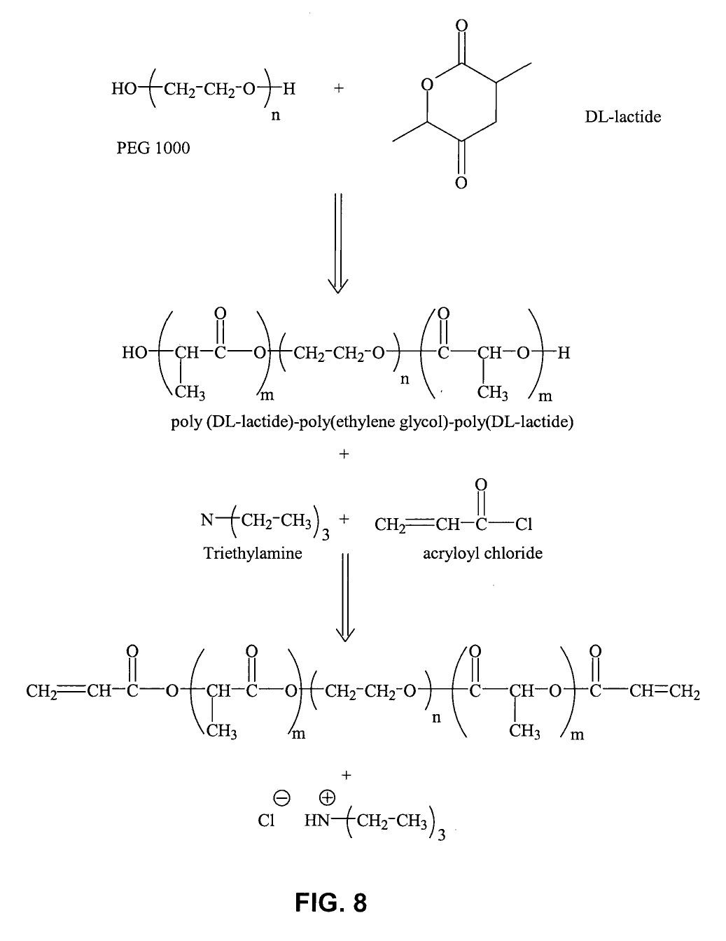

In an exemplary embodiment, a lactide or glycolide polymer can be derivatized so that the polymer has carbon-carbon double bonds on one or both ends of the polymer chain. For example, a poly(DL-lactide)-poly(ethylene glycol)-poly(DL-lactide) (PDLA-PEG-PDLA) copolymer can be derivatized to form a copolymer with carbon-carbon double bonds at each end of the chain. A synthetic route to forming the reactive copolymer is depicted in FIG. 8. FIG. 8 shows that polyethylene glycol and DL-lactide react to form PDLA-PEG-PDLA copolymer, the reaction occurs at 160° C., under a nitrogen blanket, and is catalyzed by stannous 2-ethylhexanoate. The PDLA-PEG-PDLA copolymer reacts with tryethylamine and acryloyl chloride to form PDLA-PEG-PDLA copolymer with carbon-carbon double bond end groups. Upon exposure to UV radiation, a reaction mixture including PDLA-PEG-PDLA copolymer with carbon-carbon double bond end groups can crosslink.

Radiation induced crosslinking or polymerization is particularly advantageous since the crosslinking or polymerization can be completed in a relatively short period of time. For example, for a stent-sized sample, the crosslinking or polymerization can be completed within about one minute. Additionally, the crosslinking or polymerization reaction can be performed at temperatures at which there is little or no degradation of the polymer. In one embodiment, radiation induced crosslinking can be performed at ambient temperatures, e.g., between 15° C. and 25° C. This can be contrasted with solid state polymerization. Solid state crosslinking of poly(lactides) have been performed at temperatures in excess of 110° C. with reaction times from 20 hours to 96 hours. U.S. Pat. No. 6,352,667.

The “glass transition temperature,” Tg, is the temperature at which the amorphous domains of a polymer change from a brittle vitreous state to a solid deformable or ductile state at atmospheric pressure. In other words, the Tg corresponds to the temperature where the onset of segmental motion in the chains of the polymer occurs. When an amorphous or semicrystalline polymer is exposed to an increasing temperature, the coefficient of expansion and the heat capacity of the polymer both increase as the temperature is raised, indicating increased molecular motion. As the temperature is raised the actual molecular volume in the sample remains constant, and so a higher coefficient of expansion points to an increase in free volume associated with the system and therefore increased freedom for the molecules to move. The increasing heat capacity corresponds to an increase in heat dissipation through movement. Tg of a given polymer can be dependent on the heating rate and can be influenced by the thermal history of the polymer. Furthermore, the chemical structure of the polymer heavily influences the glass transition by affecting mobility.

Polymers can be biostable, bioabsorbable, biodegradable or bioerodable. Biostable refers to polymers that are not biodegradable. The terms biodegradable, bioabsorbable, and bioerodable are used interchangeably and refer to polymers that are capable of being completely degraded and/or eroded when exposed to bodily fluids such as blood and can be gradually resorbed, absorbed, and/or eliminated by the body. The processes of breaking down and eventual absorption and elimination of the polymer can be caused by, for example, hydrolysis, metabolic processes, bulk or surface erosion, and the like.

It is understood that after the process of degradation, erosion, absorption, and/or resorption has been completed, no part of the stent will remain or in the case of coating applications on a biostable scaffolding, no polymer will remain on the device. In some embodiments, very negligible traces or residue may be left behind. For stents made from a biodegradable polymer, the stent is intended to remain in the body for a duration of time until its intended function of, for example, maintaining vascular patency and/or drug delivery is accomplished.

Representative examples of polymers that may be used to fabricate or coat an implantable medical device include, but are not limited to, poly(N-acetylglucosamine) (Chitin), Chitosan, poly(hydroxyvalerate), poly(lactide-co-glycolide), poly(hydroxybutyrate), poly(hydroxybutyrate-co-valerate), polyorthoester, polyanhydride, poly(glycolic acid), poly(glycolide), poly(L-lactic acid), poly(L-lactide), poly(D,L-lactic acid), poly(D,L-lactide), poly(caprolactone), poly(trimethylene carbonate), polyester amide, poly(glycolic acid-co-trimethylene carbonate), co-poly(ether-esters) (e.g. PEO/PLA), polyphosphazenes, biomolecules (such as fibrin, fibrinogen, cellulose, starch, collagen and hyaluronic acid), polyurethanes, silicones, polyesters, polyolefins, polyisobutylene and ethylene-alphaolefin copolymers, acrylic polymers and copolymers other than polyacrylates, vinyl halide polymers and copolymers (such as polyvinyl chloride), polyvinyl ethers (such as polyvinyl methyl ether), polyvinylidene halides (such as polyvinylidene chloride), polyacrylonitrile, polyvinyl ketones, polyvinyl aromatics (such as polystyrene), polyvinyl esters (such as polyvinyl acetate), acrylonitrile-styrene copolymers, ABS resins, polyamides (such as Nylon 66 and polycaprolactam), polycarbonates, polyoxymethylenes, polyimides, polyethers, polyurethanes, rayon, rayon-triacetate, cellulose, cellulose acetate, cellulose butyrate, cellulose acetate butyrate, cellophane, cellulose nitrate, cellulose propionate, cellulose ethers, and carboxymethyl cellulose. Another type of polymer based on poly(lactic acid) that can be used includes graft copolymers, and block copolymers, such as AB block-copolymers (“diblock-copolymers”) or ABA block-copolymers (“triblock-copolymers”), or mixtures thereof. Additional representative examples of polymers that may be especially well suited for use in fabricating or coating an implantable medical device include ethylene vinyl alcohol copolymer (commonly known by the generic name EVOH or by the trade name EVAL), poly(butyl methacrylate), poly(vinylidene fluoride-co-hexafluororpropene) (e.g., SOLEF 21508, available from Solvay Solexis PVDF, Thorofare, N.J.), polyvinylidene fluoride (otherwise known as KYNAR, available from ATOFINA Chemicals, Philadelphia, Pa.), ethylene-vinyl acetate copolymers, and polyethylene glycol.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A method of fabricating a stent comprising:
disposing a molten reaction mixture into a mold, the mold being in the shape of a radially expandable stent including at least one structural element, the reaction mixture comprising reactive species capable of causing polymerization or crosslinking in the reaction mixture upon exposure to radiation; and
after disposing the reaction mixture into the mold, exposing the reaction mixture to radiation, the radiation causing polymerization or crosslinking in the reaction mixture, the stent being formed from a polymer formed from the polymerization or crosslinking.

2. The method of claim 1, wherein the polymer is a biostable polymer, biodegradable polymer, or a combination thereof.

3. The method of claim 1, wherein the reaction mixture comprises a polymer, monomer, a pre-polymer, or a combination thereof.

4. The method of claim 1, wherein the reactive species comprise reactive groups capable of causing polymerization or crosslinking upon exposure to radiation.

5. The method of claim 4, wherein the reactive groups comprise carbon-carbon double bonds.

6. The method of claim 1, wherein the reaction mixture is solidified prior to exposing the reaction mixture to the radiation.

7. The method of claim 1, wherein the reaction mixture is exposed to radiation while in the mold.

8. The method of claim 1, further comprising removing the reaction mixture from the mold prior to the exposing of the reaction mixture to the radiation.

9. The method of claim 1, wherein the reaction mixture comprises PDLA-PEG-PDLA copolymer with a carbon-carbon double bond.

10. The method of claim 1, wherein the reaction mixture includes a prepolymer prepared from a monomer selected from the group consisting of L-lactide, D-lactide, DL-lactide, and gylocolide.

11. The method of claim 1, wherein the reaction mixture includes a prepolymer prepared from an L-lactide monomer.

12. The method of claim 1, wherein the exposing of the reaction mixture to the radiation is performed while the reaction mixture is molten.

13. The method of claim 1, further comprising cooling the reaction mixture to a solid prior to the exposing of the reaction mixture to the radiation.

14. The method of claim 1, wherein the mold is in the shape of a radially expandable stent having undulating struts forming ring structures, each ring structure connected to an adjacent cylindrical structure by at least one longitudinal strut.
